(19) United States
(12) Patent Application Publication
(10) Pub. No.: US 2013/0174740 A1
(43) Pub. Date: Jul. 11, 2013

(54) AIR FILTER UNIT

(71) Applicants: Onofrio AZZARETTO, Miami, FL (US); Holger GALGENMULLER, Wadgassen (DE)

(72) Inventors: Onofrio AZZARETTO, Miami, FL (US); Holger GALGENMULLER, Wadgassen (DE)

(21) Appl. No.: 13/347,455

(22) Filed: Jan. 10, 2012

(51) Int. Cl. B01D 46/42

(52) U.S. Cl. 96/222

(57) ABSTRACT

An air filter unit, including a filter medium held on reels, a drive mechanism for automatic filter reeling, having a filter medium in the form of an exchangeable filter element inserted in a recess in the air filter unit; the filter element comprising a housing featuring two parallel shafts located at opposite sides of the frame; the shafts being located at a distance from each other that allows for the taut positioning of the effective filter area between them; whereby at least one of the shafts is detachably connected to at least one force transfer element attached to an electric drive installed in the air filter unit and driven by an electric drive; including an exchangeable air freshener cartridge placed inside or to the side of the air filter unit, releasing air freshener to the filter medium through at least one valve.

### FIELD

This invention concerns an air filter unit which is, in some embodiments, designed primarily for stationary air-conditioning systems.

### BACKGROUND

In principle, stationary air-conditioning systems take up the air from the room to be air-conditioned through an air filter, in order to clean the air by means of the paper filter insert in the air filter. In such systems, the air filter must be regularly serviced, whereby the service interval is determined by the amount of dirt particles in the air taken in from the room.

As the dirt particles collecting in the air filter cannot be decomposed in the filter, it is becoming gradually more clogged up, so that its effectiveness is impaired. Such air filters are installed in order to ensure that only pre-cleaned air is fed through the actual air-conditioning system for cooling or heating. Preliminary filtration prevents that dirt particles are kept in circulation by passing through the air-conditioning system and being released back into the room.

It is customary practice to leave it up to the user to determine when the air filter needs to be serviced. This often results in a situation where the air filter is replaced too late so that the air in the room becomes more contaminated with dirt particles.

As is known from the state of technology revealed in the Korean patent publication KR 1020050403362 A, a filtration device for an air-conditioning system can be designed to include a warning function that alerts the user if the filter is excessively contaminated and that automatically changes the filter. The filter paper is supplied as a strip on a reel held between two rolls. At intervals determined by the system settings, it is reeled up on one roll so that a clean filter section is dispensed from the second roll to be placed in front of the air-conditioning unit.

The main disadvantage of this solution lies in its construction. The filter unit consists of a housing that resembles the formerly widely known pocket or Instamatic film cartridges. At the centre of the unit, there is a window or aperture through or over which the filter paper is transferred. This window is located between two cylinder-shaped holders, one fitted with a reel of new filter paper and the other holding the roll on which the spent filter paper is reeled up.

To change the filter, the spent filter paper roll is to be removed from the second holder of the device and a new filter reel is to be inserted in the first holder on the other side of the window. The protruding end of the new filter reel must be secured to the roll in the second holder so that the filter can again be reeled up as it is being used.

This procedure is again similar to that used to load a film reel in a medium format camera. As changing filter is therefore a rather time-consuming task that requires some dexterity, it goes somehow against the main purpose of the device, which is the regular renewal of the air filter.

Another disadvantage of this construction is its installation on rails at the air-conditioning system, as not all air-conditioning system designs allow for such a fixture. The solution is also rather unattractive.

### SUMMARY

Based on this background, the invention presented here aims at providing an air filter unit for stationary air-conditioning systems that offers automatic air filter change as well as easy replacement of the air filter unit. In addition, the air filter unit is to be designed to fit all air-conditioning systems and to allow for inconspicuous installation. Furthermore, it must be suitable to achieve the desired room air quality.

These objectives can be met with the invention of an air filter unit designed for installation in conventional air-conditioning systems. Its main components are an external housing that includes a drive motor and electronic parts as well as the exchangeable components of the air filter unit. The exchangeable components are consumables that can be re-conditioned after use. The external housing must therefore be purchased and installed only once, while the consumables can be renewed as often as required.

### BRIEF DESCRIPTION OF THE DRAWINGS

One or more embodiments are illustrated by way of example, and not by limitation, in the figures of the accompanying drawings, wherein elements having the same reference numeral designations represent like elements throughout and wherein:

FIG. 1 is a top view of a housing comprising an air filter unit according to an embodiment.

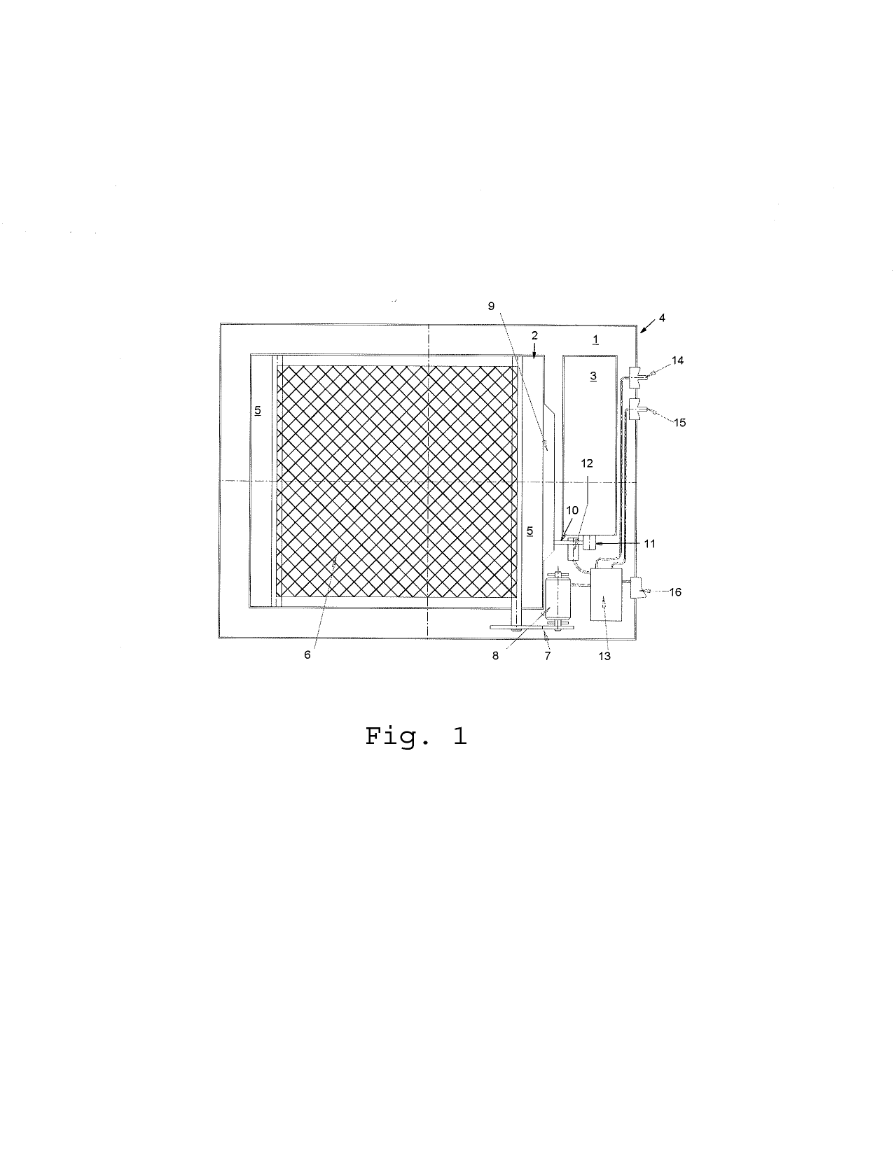

### DESCRIPTION

The invention is a filter medium in the form of an exchangeable filter element inserted in a recess in the air filter unit. The filter element is consisting of a housing featuring two parallel shafts located at opposite sides of the frame and these shafts are located at a distance from each other that allows for the taut positioning of the effective filter area between them, whereby at least one of the shafts is detachably connected to at least one force transfer element permanently attached to the electric drive installed in the air filter unit and driven by the electric drive. The device is including an exchangeable air freshener cartridge placed inside or to the side of the air filter unit, releasing air freshener to the filter medium through at least one valve.

The exchangeable filter element is a separate invention for incorporation in the air filter unit. It consists of a frame equipped with two shafts holding the filter paper. It features a power supply connection for mains or battery power and a transmission mechanism consisting of a drive gear mechanism or drive wheel. The filter paper is equipped with a protective cover, for example in the form of a protective grid.

In contrast to the current state of technology, the exchangeable filter element forms a single, disposable unit for insertion in the external housing. There is therefore no need to load filter paper into the reeling mechanism. On the one hand, this approach is more user-friendly, as the solution does away with the tricky task of threading the filter paper into the reeling mechanism. On the other, the solution is more hygienic, as the contaminated filter paper reel remains in the unit and is disposed together with it. Contact with the filter paper, that might be highly contaminated, can thus be avoided.

The air filter unit is incorporated into an external housing that contains all components and shows an external frame that covers the air intake opening of the air-conditioning system and that features a centre opening onto which the filter system is mounted.

The shafts of the exchangeable filter element are located at the two sides of the unit, so that the filter paper is held between the two shafts. It is proposed that the filter paper is gradually reeled off from one shaft and reeled up on the other shaft, whereby the entire exposed filter paper area is renewed at each reeling process. Alternatively, the filter paper can be transferred from one reel to the other at a continuous preset or time-controlled rate. As explained later in this document, at least one of the shafts is driven by a suitable drive mechanism, whereby the force is transferred from a permanently installed drive unit to the exchangeable filter element through mechanical components, such as gear wheels, that are integrated into the exchangeable filter element.

The protective covers such as the protective grid of the filter paper hold the paper in position so that it is not moved by the forced air flow through the filter. The protective grid also protects the filter paper against mechanical impact that could damage the paper and thus impair its effectiveness.

The external housing features a receiving recess for the housing of the exchangeable filter unit. This recess is equipped with a locking mechanism and a solution for the force transfer from the drive motor, which is integrated in the external housing. This drive system might for example consist of gear wheels engaging with the drive motor unit.

This solution is a clear improvement over the current state of technology, as the invention separates the drive motor unit and the exchangeable filter unit. The exchangeable filter unit therefore needs only to be equipped with a gear mechanism that transfers the rotation from the drive installed in the external housing to at least one filter reel shaft.

An air freshener spray cartridge is installed in a separate receiving recess in the external housing. The external housing thus includes all components in a single, visually attractive unit.

It is envisaged to design the air freshener cartridge as a pressurised spray can for insertion in the filter system. The air freshener cartridge is connected with a hose to an atomiser shaft of the air filter unit. After placing the cartridge in the filter unit, a hand valve is actuated manually so that the air freshener liquid to be atomised is pressurised. An electric check valve is opened at preset intervals or on request and the pressurised air fresher liquid is sprayed into the atomiser shaft. From here, the air freshener is distributed evenly across the filter paper.

It is envisaged to offer several different air freshener scents. In the event that larger quantities of air freshener are required, as a result of very short spray intervals, an alternative external housing design can be implemented, whereby a larger air freshener cartridge is placed beside the filter housing. This larger cartridge is connected in the same way with a connecting hose to the filter system as the smaller cartridge placed inside the external housing.

The outer frame of the housing is to be designed in such a way that the inlet for air freshener is fully covered. As the dimensions of air-conditioning systems from the various manufacturers vary, the outer dimensions of the outer air filter unit frame must be adjusted to suit these different dimensions.

One version of the invention is envisaged to be equipped with an adjustable outer frame. The frame can for example be made smaller by removing parts of it along perforations, which can be done easily by hand. All frame versions feature however the same centre recess into which the entire filter system is to be installed and secured. The filter unit can be mounted directly on the air intake of the air-conditioning system or below the air intake. In all cases, all air taken in by the air-conditioning system must pass the air filter unit so that no unfiltered air enters the air-conditioning system.

The explanations below refer to the drawing of the invention. The drawing shows a top view of the air filter unit 4 with inserted exchangeable filter element 2 and air-freshener cartridge 3. All components of the invention are arranged in an external housing 1.

The receiving recess for the filter unit 2 is located to the left and takes up approximately three quarters of the entire space available in the housing. The right section houses the technical components and the air freshener cartridge in the form of a spray can 3.

The version shown here features a filter element 2 protected by a grid 6 that protects the paper against mechanical impact and ensures that it is held plane. The two filter reels 5 (not shown in the drawing) are located on either side of the filter element, whereby the bottom right corner features a force transfer element 7 connected to the electric motor 8, transferring the rotary movement of the drive mechanism to the right filter reel 5.

To the right of the filter reel 5, the unit features a vertical atomiser shaft 9. This shaft is filled with atomised air freshener from the air freshener cartridge 3 through a connecting hose 10. This hose 10 is connected to the valve 11 of the air freshener cartridge 3. An electric valve 12 that can be opened and closed regulates the supply of air freshener to the hose. As the air freshener is pressurised, the valve 12 controls the release of the air freshener from the inserted cartridge. The air freshener cartridge is connected to the hose 10 by means of a valve that is constantly open.

Other components in the external housing include a printed circuit board 13 for the control of the filter change interval and the air freshener release interval. The version shown in the drawing is equipped with two knobs 14 and 15, used for example to adjust the time-controlled movement of the filter and the release intervals of air freshener. The filter unit might also be controlled based on the actual operating hours of the air-conditioning system. The switch 16 serves as a power switch with which the air filter unit can be switched on and off.

What is claimed is:

1. An air filter unit, including a filter medium held on reels, a drive mechanism for automatic filter reeling,
comprising:
a filter medium in the form of an exchangeable filter element inserted in a recess in the air filter unit;
the filter element comprising a housing featuring two parallel shafts located at opposite sides of a frame; the shafts being located at a distance from each other that allows for the taut positioning of the effective filter area between them;
whereby at least one of the shafts is detachably connected to at least one force transfer element attached to an electric drive installed in the air filter unit and driven by the electric drive;
including an exchangeable air freshener cartridge placed inside or to the side of the air filter unit, releasing air freshener to the filter medium through at least one valve.

2. The air filter unit according to claim 1, wherein the air filter unit is incorporated into an external housing that contains the components and an external frame that covers the air intake opening of an air-conditioning system and that features a centre opening onto which the filter unit is mounted.

3. The air filter unit according to claim 2, wherein the frame is an adjustable outer frame adaptable to suit the various air intake opening sizes of air-conditioning systems.

4. The air filter unit according to claim 1, further comprising
an integrated automated control system controlling the filter change and transport and/or the release of air freshener.

5. The air filter unit according to claim 1, wherein the
air freshener cartridge is a pressurised spray can connected by a hose to an atomiser shaft through which the air freshener is released to the filter medium;
whereby a manually actuated valve is permanently locked in open position for as long as the air freshener cartridge is installed in the filter unit, and a second check valve controls the air freshener release to the filter medium.

6. The air filter unit according to claim 1, wherein
the filter element is an exchangeable and disposable product.
